(19) United States
(12) Patent Application Publication
(10) Pub. No.: US 2009/0311075 A1
(43) Pub. Date: Dec. 17, 2009

(54) SELF-TAPPING DRILL SCREW

(75) Inventors: Michael Achenbach, Breidenbach (DE); Eberhard Christ, Tambach-Dietharz (DE); Heinrich Friederich, Altenstadt (DE); Gottfried König, Bad Laasphe (DE)

Correspondence Address: BIRCH STEWART KOLASCH & BIRCH, PO BOX 747, FALLS CHURCH, VA, 22040-0747, US

(73) Assignee: EJOT GmbH & Co. KG, Bad Laasphe (DE)

(21) Appl. No.: 12/307,717

(22) PCT Filed: Jul. 23, 2007
(86) PCT No.: PCT/EP07/06536

§ 371 Date: Jun. 5, 2009

(30) Foreign Application Priority Data
Jul. 26, 2006 (DE) 10 2006 034 585.1

(51) Int. Cl. F16B 25/10

(52) U.S. Cl. 411/387.4

(57) ABSTRACT

The invention relates to a self-tapping drill screw that is screwable into a sheet piece and comprises a slotted head for accommodating a tool, a threaded shank, a slightly conically tapering hole-forming part and a hole-grinding part having a conical piece. The hole-grinding part has a radial shoulder that forms a hole and coaxially surrounds the conical piece, engagable with the sheet piece, in a ring-like manner, has a much larger diameter than the conical piece and merges with the hole-forming part via a rounded annular edge.

The invention relates to a self-tapping drill screw that is screwable into a sheet piece and comprises a slotted head for accommodating a tool, a threaded shank, a slightly conically tapering hole-forming part and a hole-grinding part.

A screw of this type is known from European Patent Application 0 464 071 B1. This screw uses a hole-grinding part which is designed as a conical piece that ends in a rounded point. This point engages with a sheet piece so that the sheet piece material softens when the screw rotates, and the conical piece is able to penetrate the sheet piece and thereby form a hole in the sheet piece. The conical piece is steplessly connected to a conical hole-forming part of an essentially narrow design, which penetrates the hole formed by the hole-grinding part and subsequently expands it to its maximum diameter, using frictional heat resulting from the rotary motion of the screw. The sheet part material thus forms a passage that extends on both sides of the sheet part, in particular, therefore, on the side from which the screw engages with the sheet part. However, the passage is frequently undesirable on this side.

According to German Utility Model 20 2005 017 524.2, a design of a fastening element embodied as a friction welding bolt is provided, in which a blunt point of a conical end of the bolt causes the surface of a workpiece to melt on the basis of correspondingly rapid rotation and pressure of the bolt against the workpiece, the molten material being able to flow to the side. The blunt point is surrounded by a shoulder having a coaxial hollow channel that accommodates the molten material. However, this design is not suitable for use as a self-tapping drill screw, since the penetration of a component with which the fastening element engages is to be avoided during use of the screw.

The object of the invention is to produce a self-tapping drill screw which, when forming a hole in a sheet piece for screwing in a thread later on, a passage is essentially created only on the side facing away from the side on which the screw engages with the sheet piece. In addition, the screw must be designed in such a way that the heat needed to form the hole may be generated in a particularly short amount of time after the screw engages with the sheet piece.

This object is achieved according to the invention by designing the hole-grinding part as a radial shoulder that coaxially surrounds a conical piece, engagable with the sheet piece, in a ring-like manner, has a diameter that is much larger than that of the conical piece and merges with a rounded annular edge in the hole forming part.

The screw according to the invention uses its hole-grinding part designed as a radial shoulder to apply a pressure when the screw is pressed onto the sheet piece, the pressure giving the sheet piece material softened during screw rotation as a result of frictional heat the tendency to yield to the radial shoulder in the direction of the pressure applied to the sheet piece and thereby to form a passage having a smooth edge, which ordinarily does not cause interference on the side of the sheet piece facing away from the screw and, in any case, does not have the tendency to extend to the engagement side of the sheet piece. To a certain extent, this results in a two-stage handling of the sheet piece, in which a hole is first driven into the sheet piece by the hole-grinding part of the screw engaging with the sheet piece and rotating, the radial shoulder of the hole-grinding part engaging with the sheet piece and pressing upon it, whereby all the material formed from the sheet piece and softened by the frictional heat flows to the passage on the side of the sheet piece facing away from the screw engagement side, after which the hole-forming part slides into the hole via the rounded, annular edge and expands the hole and the passage to the maximum diameter of the hole-forming part. This essentially results in a passage on the side of the sheet piece facing away from the screw, the passage also being solidly formed and free of any jagged edges, as may otherwise occur in passages of this type.

There are various possible designs of the radial shoulder. It may be designed in such a way that it runs mainly at a 90° angle to the screw axis. However, it is also possible to design the radial shoulder as a blunt cone. This design has a particularly positive effect on the flow action of the sheet piece material.

It is also possible to give the radial shoulder a concave, arched design. The individual design of the radial shoulder largely depends on the sheet piece material. The design of the radial shoulder also has a positive effect on the pressure to be applied and the rotational speed.

The screw is effectively guided during the screwing motion by the fact that the conical piece projects axially beyond the radial shoulder, since the conical piece then performs a certain centering action after it engages with a sheet piece.

There are different ways to design the conical piece as a component of the hole-grinding part. The conical piece may merge with a blunt, rounded end piece, as disclosed for example, in EP 0 464 071 B1, The conical niece may also be made to end in a point, which, however, requires a relatively high pressure to be applied to the point in order to form a hole. In a further particularly advantageous design of the conical piece, the latter is provided with a coaxial indentation that is surrounded by a blunt edge whose outer diameter (d) is 0.35 to 0.7 times smaller than the maximum diameter (D) of the hole-forming part. In this design, the sheet piece heats to a greater extent even at relatively low rotational speeds, due to the edge around the indentation, this heating being sufficient to form the hole in the sheet piece. It is sufficient to produce the indentation in such a way that it is shorter than 3 mm in length.

The annular edge may be advantageously provided with an arch that projects over the radial shoulder in the region where it merges with the hole-forming part, this arch ensuring that the material is pressed out of the sheet piece mainly in the direction of the passage being formed. This has a positive effect on the formation and design of the passage.

Exemplary embodiments of the invention are illustrated in the figures, where:

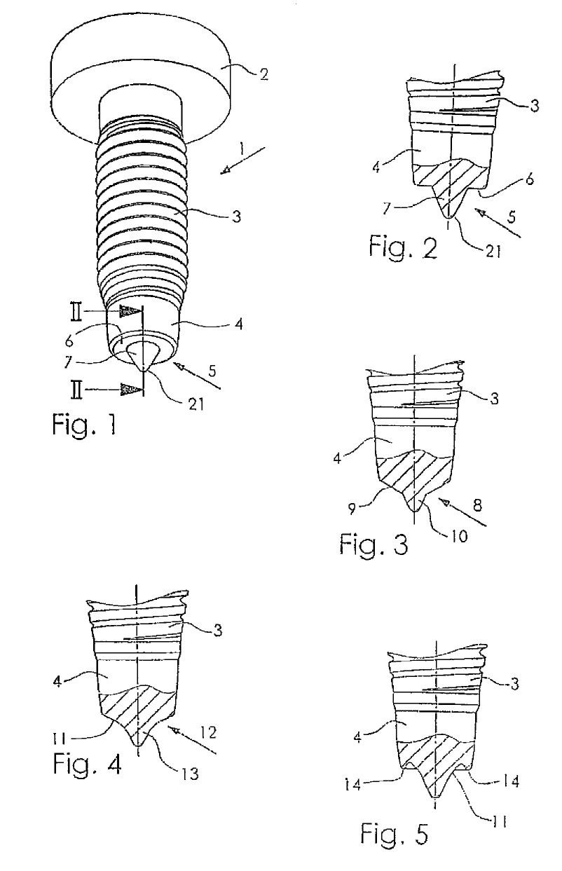

FIG. 1 shows a perspective view of the screw;

FIG. 2 shows a cross-sectional view along line II-II from FIG. 1, including the radial shoulder running in the radial direction;

FIG. 3 shows a similar cross-section, including a conical radial shoulder;

FIG. 4 shows a similar cross-section, including an concave, arched radial shoulder;

FIG. 5 shows a similar cross-section, including a rounded arch that projects over the radial shoulder;

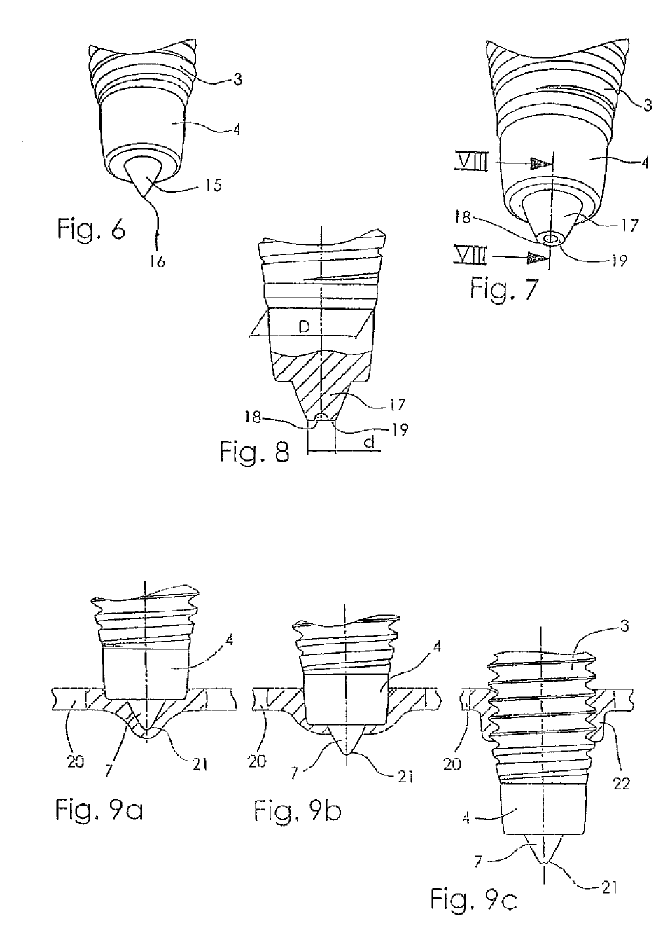

FIG. 6 shows the hole-grinding part, including a conical piece that ends in a point;

FIG. 7 shows a hole-grinding part, including a conical piece having a coaxial indentation;

FIG. 8 shows a cross-sectional view along line VIII-VIII from FIG. 7;

FIGS. 9a, b and c show a screw according to FIG. 1 in different phases of penetration of and passage through a sheet piece.

FIG. 1 shows a perspective view of self-tapping drill screw 1 according to the invention. The screw includes screw head 2, threaded shank 3 and hole-forming part 4, which is located above hole-grinding part 5. The hole-grinding part includes radial shoulder 6 and conical piece 7. To screw screw 1 into a sheet piece (see FIGS. 9a through c), conical piece 7 engages with the sheet piece and is rotated. Due to the resulting frictional heat, conical piece 7 penetrates the sheet piece until radial shoulder 6 also strikes the sheet piece and, as a result of its relatively large diameter, quickly heats the relevant region of the sheet piece. Radial shoulder 6 pushes the softened material forward and out of the sheet piece, i.e., in the direction toward the side of the sheet piece facing away from screw 1, so that a passage formed from the softened sheet piece material essentially forms on this side of the sheet piece facing away from the screw (see FIGS. 9a through c). The radial shoulder thus performs a dual function, since, on the one hand, it favorably ensures rapid heading of the sheet piece material and, on the other hand, pushes the heated and therefore softened material forward and out of the sheet piece on the side of the sheet piece facing away from the screw.

Conical piece 7 used in screw 1 according to FIG. 1 has a rounded end 7a which, when engaging with a sheet piece, ensures that a contact over a wide area, and thus corresponding frictional heat, is quickly produced on the sheet piece under correspondingly high pressure. This is particularly advantageous if screw 1 is to be screwed into a sheet place made of a relatively hard material, such as a sheet piece made of steel.

In FIG. 2, which shows a cross-sectional view along line II-II from FIG. 1, radial shoulder 6 runs at a 90° angle to the axis of screw 1, which results in immediate heating of a sheet piece over a wide area as a result of the rotary motion of screw 1 when radial shoulder 6 strikes the sheet piece.

It may also be desirable to increase the pressure being applied by radial shoulder 6 as hole-forming part 5 penetrates ever farther into the material of a sheet piece, i.e., it may be desirable to begin at a lower pressure and change to a higher pressure, which is achievable by a design as shown in FIG. 3. This figure shows a cross-sectional view similar to the one according to FIG. 2, which illustrates a hole-grinding part 8 whose radial shoulder 9 is shaped like a blunt cone. As a result of this design, only central conical piece 10 initially penetrates the sheet piece material until the inner region of radial shoulder 9 engages and presses against the edge of the resulting hole as the diameter increases, which produces a transition to a higher application of pressure and ultimately the application of maximum pressure to the sheet piece upon reaching the outer edge of radial shoulder 9.

FIG. 4 shows a similar design, which is also a cross-sectional view similar to the one according to FIG. 2. In this case, radial shoulder 11 of hole-grinding part 12 has a concave, arched shape, which further equalizes the transition of the frictional load from the region of central conical piece 13 to radial shoulder 11.

FIG. 5 shows a particular design of the hole-grinding part. In this case, concave, arched radial shoulder 11 merges with a projecting annular edge 14 on its outer edge, the annular edge more or less capturing and containing material that has become movable during the softening of the sheet piece material and making practically all of this material available to a passage that forms on the side of the sheet piece facing away from the screw.

FIG. 6 shows a further variant of the conical piece. Conical piece 15 illustrated here ends in a point 16, which is advantageous, in particular, when applying the screw to a relatively soft material, such as aluminum.

FIGS. 7 and 8 show a particular design of the conical piece, FIG. 8 showing a cross-sectional view along line VIII-VIII from FIG. 7. In this case, conical piece 17 has a coaxial indentation 18 on its end, this indentation being surrounded by a blunt edge 19. This blunt edge 19 has an outer diameter of 2 mm, compared to a maximum diameter of conical piece 17 of 5 mm. Due to blunt edge 19, a relatively large area is immediately produced when conical piece 17 engages with a sheet piece, resulting in a correspondingly great degree of heating when the screw rotates, which substantially facilitates its penetration of the sheet piece. Indentation 18 is formed by a short bore, which is approximately 2 mm deep.

FIGS. 9a, b and c show a screw being screwed into a sheet piece 20 and a passage 22 being formed, based on the screw design illustrated in FIG. 1. According to FIG. 9a, conical piece 7, which is rounded on its end 21, has penetrated the material of sheet piece 20 and has softened it accordingly. According to FIG. 9b, conical piece 7 has passed all the way through sheet piece 20. As the screw continues to pass through the sheet piece, screw 1 assumes the position illustrated in FIG. 9c, in which threaded shank 3 has passed through sheet piece 20 and produced passage 22, which in this case lies only on the side facing away from the side where the screw engages with sheet piece 20.

1-10. (canceled)

11. A self-tapping drill screw (1) that is screwable into a sheet piece (20), comprising a slotted head (2) for accommodating a tool, a threaded shank (3), a slightly conically tapering hole-forming part (4) and a hole-grinding part (5, 8, 12) having a conical piece, characterized in that the hole-grinding part (5, 8, 12) is designed as a radial shoulder (6, 9, 11) that forms a hole and coaxially surrounds the conical piece (7, 10, 13, 15, 17), engagable with the sheet piece (20), in a ring-like manner, has a much larger diameter than the conical piece (7, 10, 13, 15, 17) and merges with the hole-forming part (4) via a rounded annular edge (14).

12. The screw according to claim 11, characterized in that the radial shoulder (6) essentially runs at a 90° angle to the screw axis.

13. The screw according to claim 11, characterized in that the radial shoulder (9) forms a blunt cone.

14. The screw according to claim 11, characterized in that the radial shoulder (11) has a concave, arched shape.

15. The screw according to claim 11, characterized in that the conical piece (7, 10, 13, 15, 17) projects axially over the radial shoulder (6, 9, 11).

16. The screw according to claim 11, characterized in that the conical piece (7) ends in a blunt, rounded end piece (21).

17. The screw according to claim 11, characterized in that the conical piece (17) has a coaxial indentation (18) which is surrounded by an edge (19) whose outer diameter (d) is 0.25 to 0.75 times smaller than the maximum diameter (D) of the hole-forming part (4).

18. The screw according to claim 17, characterized in that the indentation (18) is less than 3 mm long.

19. The screw according to claim 11, characterized in that the annular edge (14) is designed as a rounded arch that projects axially over the radial shoulder (11).

20. The screw according to claim 12, characterized in that the radial shoulder (9) forms a blunt cone.

21. The screw according to claim 12, characterized in that the conical piece (7, 10, 13, 15, 17) projects axially over the radial shoulder (6, 9, 11).

22. The screw according to claim 13, characterized in that the conical piece (7, 10, 13, 15, 17) projects axially over the radial shoulder (6, 9, 11).

23. The screw according to claim 14, characterized in that the conical piece (7, 10, 13, 15, 17) projects axially over the radial shoulder (6, 9, 11).

24. The screw according to claim 12, characterized in that the conical piece (7) ends in a blunt, rounded end piece (21).

25. The screw according to claim 13, characterized in that the conical piece (7) ends in a blunt, rounded end piece (21).

26. The screw according to claim 14, characterized in that the conical piece (7) ends in a blunt, rounded end piece (21).

27. The screw according to claim 15, characterized in that the conical piece (7) ends in a blunt, rounded end piece (21).

28. The screw according to claim 12, characterized in that the conical piece (17) has a coaxial indentation (18) which is surrounded by an edge (19) whose outer diameter (d) is 0.25 to 0.75 times smaller than the maximum diameter (D) of the hole-forming part (4).

29. The screw according to claim 13 , characterized in that the conical piece (17) has a coaxial indentation (18) which is surrounded by an edge (19) whose outer diameter (d) is 0.25 to 0.75 times smaller than the maximum diameter (D) of the hole-forming part (4).

30. The screw according to claim 14, characterized in that the conical piece (17) has a coaxial indentation (18) which is surrounded by an edge (19) whose outer diameter (d) is 0.25 to 0.75 times smaller than the maximum diameter (D) of the hole-forming part (4).
